(19) United States
(12) Patent Application Publication
(10) Pub. No.: US 2014/0022171 A1
(43) Pub. Date: Jan. 23, 2014

(54) SYSTEM AND METHOD FOR CONTROLLING AN EXTERNAL SYSTEM USING A REMOTE DEVICE WITH A DEPTH SENSOR

(71) Applicant: Yaron Yanai, Modiin (IL)

(72) Inventor: Yaron Yanai, Modiin (IL)

(73) Assignee: Omek Interactive, Ltd., Bet Shemesh (IL)

(21) Appl. No.: 13/552,978

(22) Filed: Jul. 19, 2012

(51) Int. Cl. G06F 3/033

(52) U.S. Cl. 345/158

(57) ABSTRACT

A system and method for implementing a remote controlled user interface using close range object tracking are described. Close range depth images of a user's hands and fingers or other objects are acquired using a depth sensor. Using depth image data obtained from the depth sensor, movements of the user's hands and fingers or other objects are identified and tracked. The tracking data is transmitted to an external control device, thus permitting the user to interact with an object displayed on a screen controlled by the external control device, through movements of the user's hands and fingers.

### BACKGROUND

To a large extent, a person's interaction with electronic devices, such as computers, tablets, and mobile phones, requires physically manipulating controls, pressing buttons, or touching screens. Remote controls are often used to control a device from a distance using signals transmitted from a remote control device to a device being operated. For example, a television remote control can be used to control a television set, and some smart phones may run applications that enable the smart phones to function as remote control devices for other electronic devices. However, a frustrating aspect of many remote controls is the limited functionality of such controls, which rely on standard buttons for adjusting device functionality.

### BRIEF DESCRIPTION OF THE DRAWINGS

Examples of a system for automatically identifying movements for remotely controlling a device or system from a distance are illustrated in the figures. The examples and figures are illustrative rather than limiting.

FIG. 1A is a graphic showing an example use of a remote control depth sensor system, according to some embodiments.

FIGS. 1B-1D are schematic diagrams illustrating example components of different versions of a remote control depth sensor system, according to some embodiments.

FIG. 2 is a work flow diagram illustrating an example of a remote control depth sensor movement tracking process, according to some embodiments.

FIGS. 3A-3E are graphic images of examples of hand gestures that may be tracked, according to some embodiments.

FIG. 4 is a work flow diagram illustrating an example of system operation using a remote control depth sensor system, according to some embodiments.

FIG. 5 is a work flow diagram illustrating an example of a user interface operation using a remote control depth sensor system, according to some embodiments.

### DETAILED DESCRIPTION

Recent developments in the field of gesture recognition have shown the benefits of using gestures or movement tracking to enhance the user experience for controlling an electronic device. For example, game consoles, computers, and television sets are being developed to enable user control of the devices through the use of movement tracking. Robust and accurate tracking technology generally requires three-dimensional depth sensors and related hardware and software components for operation.

The ability to track objects using data from depth sensors depends on the quality of the data, and this quality generally depends, at least partially, on the proximity of the sensor to the object being tracked. In particular, it is not generally feasible to detect and track fine, nuanced movements of the fingers and hands based on depth sensor data when the sensor is placed several meters away from the user. However, if the sensor is placed close to the user, highly accurate tracking is possible using depth sensor data. The present disclosure describes a system for using depth sensor data from a depth sensor or depth camera placed in close proximity to the user, in order to control devices that are remote, i.e., several meters or more, from the user.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

The input to an object tracking system can be data associated with a user's movements that originates from an input device, such as a touch-screen (single-touch or multi-touch), movements of a user captured with a red, green, blue, or “RGB” camera, and movements of a user as captured using a depth sensor. In other known applications, accelerometers and weight scales can also provide data to assist in movement or gesture recognition.

U.S. patent application Ser. No. 12/817,102, entitled “METHOD AND SYSTEM FOR MODELING SUBJECTS FROM A DEPTH MAP”, filed Jun. 16, 2010, describes a method of tracking a player using a depth sensor and identifying and tracking the joints of a user's body. It is incorporated in its entirety in the present disclosure. U.S. patent application Ser. No. 13/441,271, entitled “System and Method for Enhanced Object Tracking”, filed Apr. 6, 2012, describes a method of identifying and tracking a user's body part(s) using a combination of depth data and amplitude data from a time-of-flight (TOF) camera, and is incorporated in its entirety in the present disclosure.

Robust movement or gesture recognition can be quite difficult to implement. In particular, the system should be able to interpret the user's intentions accurately, adjust for differences in movements between different users, and determine the context in which the movements are applicable.

A flexible, natural, and intuitive way of interacting with a system or device is for the system or device to interpret the movements of a user's hands and fingers in a three-dimensional space in front of a display screen, thus permitting a full range of possible configurations and movements, for example, of the human hands and fingers, or other limbs or body parts. Essentially, the familiar two-dimensional touch screen is extended into a three-dimensional interaction space that is less constrained, more intuitive, and supports a far more expressive range of gestures and interactions. U.S. patent application Ser. No. 13/532,609 entitled “System and Method for Close-Range Movement Tracking”, filed Jun. 25, 2012, describes a method of interacting with a device at close-range, and is incorporated in its entirety in the present disclosure.

To enable this intuitive type of interaction, the system should be able to fully identify the configurations and movements of a user's hands and fingers. Conventional cameras, such as RGB cameras, are insufficient for this purpose, as the data generated by these cameras is difficult to interpret accurately and robustly. In particular, an object in the images is difficult to distinguish from the background, the data is sensitive to lighting conditions, and occlusions occur between different objects in the images. In contrast, using depth sensors to track hands and fingers and other objects at close range can generate data that supports highly accurate, robust tracking of the user's hands and fingers and objects to enable this new, intuitive, and effective way to interact with systems or devices.

A depth sensor is defined as a sensor that obtains depth data for each pixel of a captured image, where depth refers to the distance between an object and the sensor itself. There are several different technologies used by depth sensors for this purpose. Among these are sensors that rely on time-of-flight (including scanning TOF or array TOF), structured light, laser speckle pattern technology, stereoscopic cameras, and active stereoscopic cameras. In each case, these cameras generate an image with a fixed resolution of pixels, where a value, typically an integer value, is associated with each pixel, and these values correspond to the distance of the object projected onto that region of the image from the sensor. In addition to depth data, the sensors may also generate color data, in the same way that conventional color cameras do, and this data can be combined with the depth data for use in processing.

The data generated by depth sensors has several advantages over data generated by conventional two-dimensional cameras. The depth sensor data greatly simplifies the problem of segmenting the background from the foreground, is generally robust to changes in lighting conditions, and can be used effectively to interpret occlusions. Using depth sensors, it is possible to identify and track both the user's hands and his fingers in three-dimensional space and in real-time. Knowledge of the positions of the user's hands and fingers can, in turn, be used to enable a natural, intuitive user experience with a virtual three-dimensional touch screen. The movements of the hands and fingers can power user interaction with various different systems, apparatuses and/or electronic devices, for example, computers, tablets, mobile phones, gaming consoles, handheld gaming consoles, and dashboard controls of an automobile. Furthermore, the applications and interactions enabled by this interface include productivity tools and games, as well as entertainment system controls (such as a media center), augmented reality, and many other forms of communication between people and devices.

Embodiments of the present disclosure enable a user to interact with a game, media center, computing device, system or platform. User movements are tracked at a close-range distance using a remote control device that has a depth sensor positioned in the user's personal space. In one example, a smart phone with a camera or other camera device may be used to capture fine movements of a user's hands and/or fingers for controlling an external controlled device, such as a television set, monitor, game platform, robotic system, weapon system, medical device, optical system, etc. Permitting a user to remotely control a device through tracking of user movements at close range is particularly useful in situations where it is desirable to avoid touching a control screen directly, such as in an operating room; during tasks in which the user's hands may be dirty, such as cooking, utility work, or in industrial environments; when the user is otherwise engaged in activities, such as driving a car or operating sophisticated equipment; or in situations where the user is wearing gloves or other protective materials.

The present disclosure describes the use of depth sensor images to more accurately identify and track objects at close range and reliably process a user's movements and gestures. The term “close range”, as used herein, generally refers to the substantially personal space or area in which a user interacts with a substantially personal device. In one embodiment, close-range depth images are typically, although not necessarily, acquired within the range of 30 cm to 50 cm. In one embodiment, close-range depth images may be acquired within the range of 0 to 3.0 meters. In some embodiments, depth images may be acquired at a distance greater than 3.0 meters, depending on the specific configuration of the system, the environment, screen size of the device, size of the device, etc.

Accurate tracking of the user's hands and fingers moving freely in three-dimensional space enables a natural and intuitive control scheme with which a user can interact with different devices in his environment. For example, through slight movements of the user's fingers, the user can select a channel or change the settings on his television, choose media to play, control a slide presentation, play a game, etc. The pixel resolution and precision of the depth data necessary to support these types of interactions may be difficult to achieve at a distance from the depth camera, for example, at a large distance of more than a few meters, which is the case if the depth sensor is placed on or around the television set to be controlled. However, if the depth camera is positioned in close proximity to the user's hands and fingers, the movements of the fingers can be detected with high accuracy, even at low pixel resolution, and control directions can be directly transmitted to the device being controlled.

The configuration, whereby the depth sensor is positioned in close proximity to the user's hands and fingers, may provide other advantages, such as a lower power requirement for TOF-based systems, and less interference from cluttered environments because the shorter range of the depth sensor does not detect the environmental interference.

Furthermore, calculations for the tracking can be done on the transmitting device (the device the depth camera or depth sensor is connected to), on the depth camera/sensor, on a remote computer, for example, with cloud computing, or even on the controlled device itself. Consequently, a flexible system having a very small form factor can be implemented.

Close-range three-dimensional sensor-based tracking provides several advantages over a touch screen-based system. For example, control is not limited to the surface of the screen (touch screen), allowing for a larger interaction area. Furthermore, the controlled device can work even if the user's hands are dirty, or the user is wearing gloves, e.g., in an operating room, with utilities work, robotics, when dealing with hazardous materials, cooking, or due to various disabilities. In one example, when close-range interaction with a remote control device is used to control a remote television set, the system described has the additional advantage of not requiring the user to look at the local (controlling) device's screen, since the user feedback is displayed on the remote television screen.

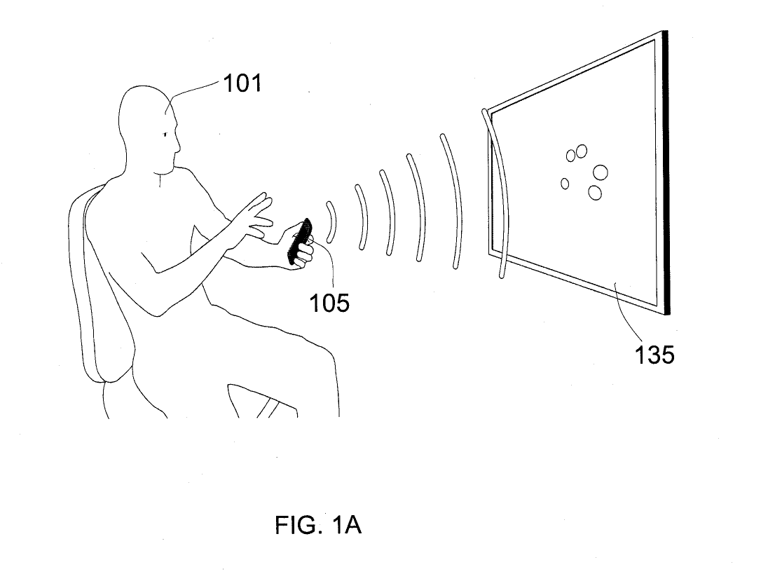

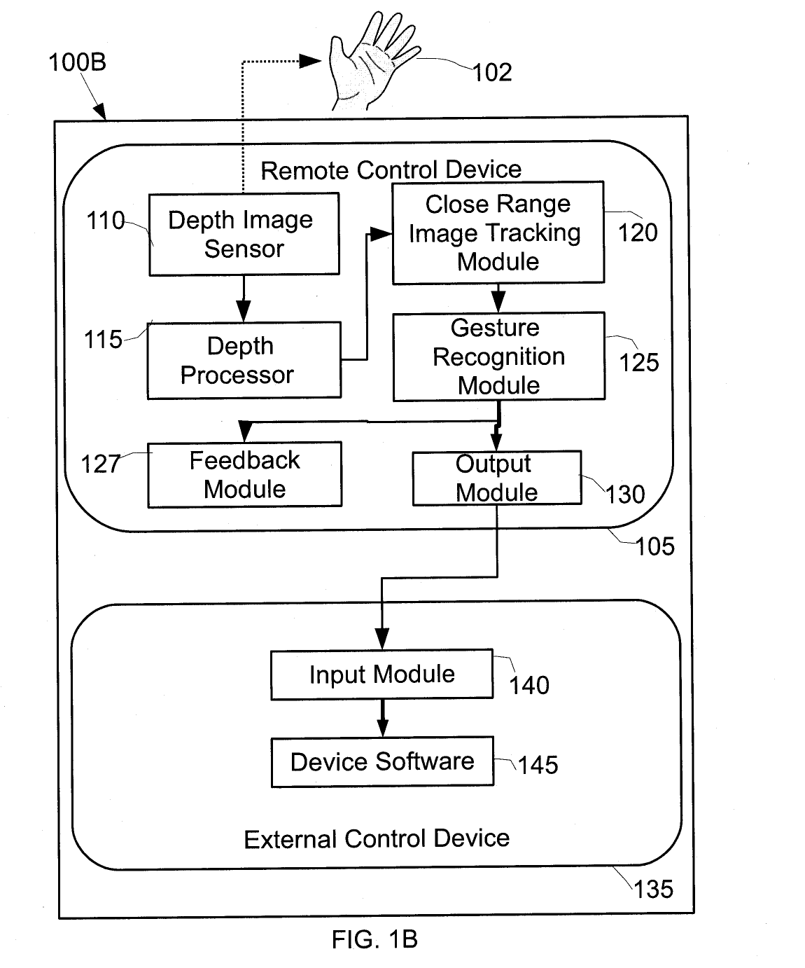

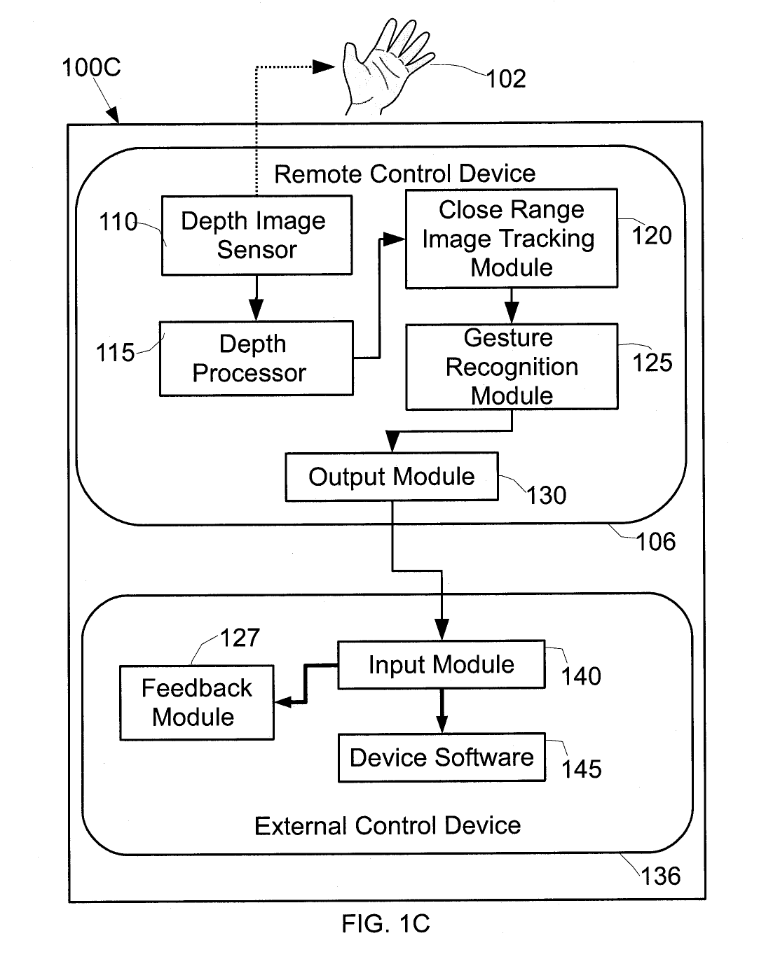

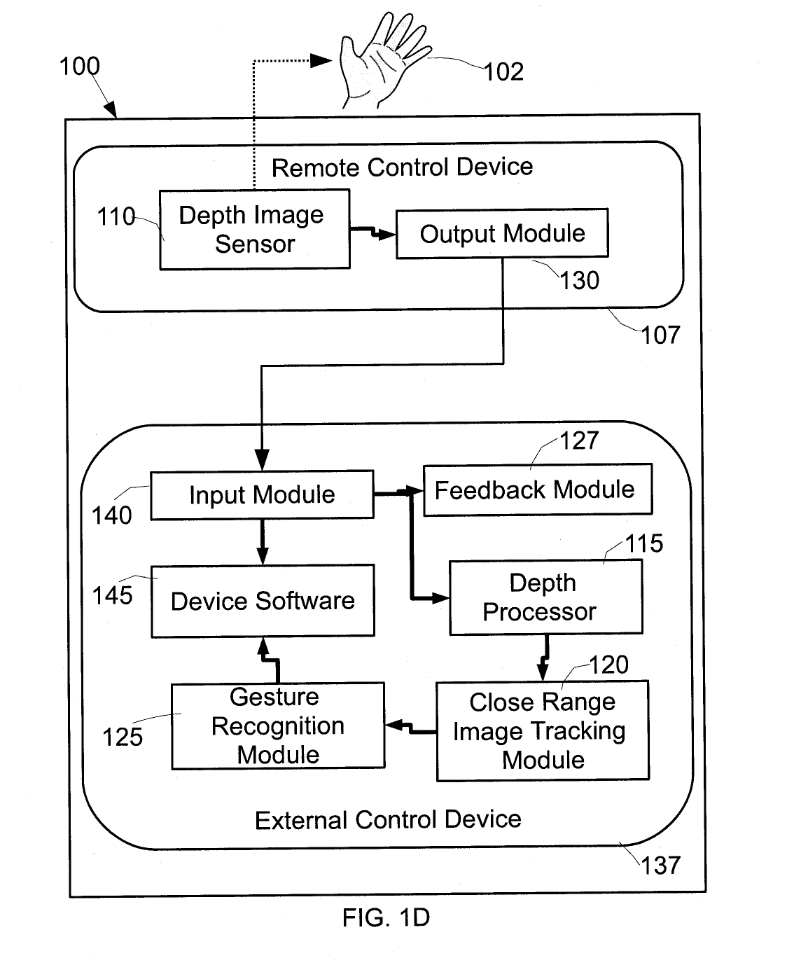

Reference is made to FIG. 1A, which is a graphic showing example usage of a remote control depth sensor system, according to some embodiments, for remotely controlling an external device using close range depth tracking. As can be seen, user 101 operates remote control device 105, to control external controlled device 135, using close range tracking of user movements within close range of the remote control device 105.

Reference is now made to FIG. 1B, which is a schematic illustration of example elements of a system 100B for remote control of a device using close range depth tracking, and the work flow between these elements, in accordance with some embodiments. As can be seen in FIG. 1B, system 100 may include a remote control device 105 and an external controlled device 135, such that the remote control device 105 enables control of the external controlled device 135, based on the tracking of a user's movements, for example movements of hand 102.

External controlled device 135 may be, for example, a television screen, monitor, game console, presentation device, gaming platform, appliance, control panel, computing or communications device, etc. Remote control device 105 may function, in some embodiments, as a universal remote controller for multiple external devices, wherein command input to the remote control device 105 is based on the user's movements.

The remote control device 105 can include, for example, a depth image sensor 110, a depth processor module 115, a close range image tracking module 120, a gesture recognition module 125, a feedback module 127, and/or an output module 130. The external controlled device 135 can include, for example, an input module 140 and/or a device software module 145. Additional or fewer components or modules can be included in the system 100, the remote control device 105, the external controlled device 135, and each illustrated component.

As used herein, a “module” includes a general purpose, dedicated or shared processor and, typically, firmware or software modules that are executed by the processor. Depending upon implementation-specific or other considerations, the module can be centralized or its functionality distributed. The module can include general or special purpose hardware, firmware, or software embodied in a computer-readable (storage) medium for execution by the processor. As used herein, a computer-readable medium or computer-readable storage medium is intended to include all mediums that are statutory (e.g., in the United States, under 35U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware

Remote control device 105 may include a depth image sensor 110, for imaging an object 102, such as a user's hand, head, foot, arm, face, or any other object being tracked or imaged in close-range. Remote control device 105 may be a dedicated sensing device, or may be integrated into a communications or computing device, such as a smart phone, tablet, mobile computer, etc. Depth image sensor 110 may be configured to support a tracking module that uses images generated by the sensor 110 to identify objects and detect object movements at close range, and even to detect fine motor movements. For example, depth image sensor 110 may be configured to provide sufficient pixel resolution and accurate depth data values in order to detect fine, nuanced movements of fingers, lips and other facial elements, toes, etc.

In general, computer vision (or “image processing”) algorithms can be performed on different types of input data, such as depth data from active sensor systems (e.g., Time of Flight (TOF), structured light, assisted stereo), depth data from passive sensor systems (e.g., such as stereoscopic), color data, amplitude data, etc. According to some embodiments, different input data types, for example RGB data, color data, amplitude data, depth data, etc., may be used to enhance close range movement tracking. Of course, one or more input data types and/or combinations of input data types may be used.

Remote control device 105 may further include a depth processor module 115, which is configured to process the depth image data to generate a depth map. The processing steps performed by the depth processor 120 are dependent upon the particular technique used by the depth image sensor 110, for example, structured light and TOF techniques.

Remote control device 105 may further include a close range image tracking module 120, for executing object tracking. In some embodiments, a depth sensor processing algorithm may be applied by tracking module 120, to enable system 100 to utilize close-range depth data received from depth processor module 115. Tracking module 120 may be enabled to process depth image data, in accordance with close range optical settings and requirements. Tracking module 120 may enable processing, calculating, identification and/or determination of object presence, movement, distance, speed, etc., for one or more objects, possibly simultaneously. Close range image tracking module 120 may, for example, execute software code or algorithms for close range tracking, for example, to enable detection and/or tracking of facial movements, finger movements, foot movements, head movements, arm movements, or other suitable object movements at close range. In one example, the tracking module 120 can track the movements of a human, and the output of tracking module 120 can be a representation of the human skeleton.

Similarly, if only a user's hands and/or fingers are being tracked, the output of tracking module 120 can be a representation of the skeleton of the user's hand. The hand skeleton can include the positions of the joints of the skeleton, and may also include the rotations of the joints. It may also include a subset of these points. Furthermore, the output of tracking module 120 can include other features, such as the center of mass of an object being tracked, or any other useful data that can be obtained by processing the data provided by the depth sensor 110.

Furthermore, the close range image tracking module 120, upon receiving data from depth sensor 110 (perhaps via the depth processor module 115), may be configured to identify shapes and/or functions of specific objects, such as the palms or the different fingers on one or both hands, to be able to identify, for example, the movements of each of the fingers, which particular finger or fingers are being moved, and an overall movement to which the individual finger movements correspond. In some embodiments, close range image tracking module 120 may be configured to identify and determine movement intensity of objects, in accordance with speed of movement, strides of movement, etc., thereby enabling a force aspect to be detected and utilized. In some embodiments, close range image tracking module 120 may be configured to track the movements of multiple fingers, and process gestures made with different fingers or combinations of fingers to enable gestures to be communicated and understood by system 100. In some embodiments, software code or algorithms for close range tracking may be used, for example, to detect and/or track facial movements, finger movements, foot movements, head movements, arm movements, and/or other suitable object movements.

Remote control device 105 may further include a movement or gesture recognition module 125 configured to classify sensed data, thereby aiding the recognition and determination of object movement. The gesture recognition module 125 may, for example, generate an output that can be used to determine whether an object is moving, signaling, gesticulating, etc., as well as to identify which specific gestures were performed.

Remote control device 105 may further include a feedback module 127, which may display or otherwise output real-time feedback such as virtual objects or graphics on a screen, sounds, vibrations, menus etc. for providing feedback to a user, such as visual, aural, or tactile feedback, and optionally allowing the user to interact with the displayed data. Non-limiting examples of feedback devices include a screen, speakers, and a vibration unit. The feedback module 127 receives input from the gesture recognition module 125. In some embodiments, the feedback module 127 may be a software application or program to provide a user-friendly user interface. Remote control device 105 may further include an output module 130 configured to process the processed tracking data, such as gesturing data, to enable user commands or actions to be satisfactorily output to external platforms, devices, consoles etc. In some embodiments, the output module 130 includes a transmitter to transmit the user commands or actions to external platforms, devices, consoles, etc.

External controlled device 135 may include an input module 140 configured to receive the output from the output module 130 and use it within the context of an application, program, or software code to be executed. Input module 140 may include software code, programs, files etc. to enable execution of device software 145. The input module 140 can include a physical input device (not shown), such as a USB receiver, that is communicatively coupled to the external controlled device 135 and receives data from the remote control device 105 and converts the data into signals that are understood by the device software module 145. Device software module 145 may execute, for example, a game, a software program, an application, etc., based on the user's tracked movements, as imaged by the depth sensor 110.

An external controlled device may be a screen projector, for example, used to project media, presentations etc. on a screen. A remote control device may be a smart phone with a depth sensor with an output module that may be used to command and control the external controlled device, using existing command and control mechanisms. The remote control device may track a user's movements and optionally recognize gestures, such as commands, to enable the user to control the external controlled device by performing movements in proximity to the remote control device. In further examples, fine user movements, such as finger movements, eye movements, facial movements etc. may be used to control the external controlled device. In even further examples, detecting the proximity of the user to the remote control device, even without tracking the fingers and palms or detecting any specific gesture may also trigger certain actions in the controlled device such as “wake up” if movement is detected, or “go to sleep” if the user leaves the area.

In still further examples, the user may control objects or other user interface (UI) elements using movements in proximity to the remote control device. For example, the user may virtually grab, hold, enter, move, etc. one or more UI elements associated with the remote control device.

FIG. 1C is a schematic illustration of elements of a system 100C for remote control of a device using close range depth tracking, wherein the remote control device 106 has no feedback module 127. Remote control device 106 may be substantially an input device, with processing and transmission capability, in accordance with some embodiments. The feedback module 127 is part of the external controlled device 136 and receives input from the input module 140.

In some embodiments, as can be seen with reference to FIG. 1D, one or more of the image tracking module 120, depth processing module 115 and gesture recognition module 125 may be located within external controlled device 137 of system 100D. In this way, remote control device 107 may be substantially a sensing device, with capabilities for transmitting depth data, while the external controlled device 137 may handle much of the critical data processing. In some embodiments, one or more of image tracking module 120, depth processing module 115 and gesture recognition module 125 may be located remotely, external to both the remote control device 107 and the external controlled device 137, e.g., within a network “cloud”. The feedback module 127 is located in the external control device 137.

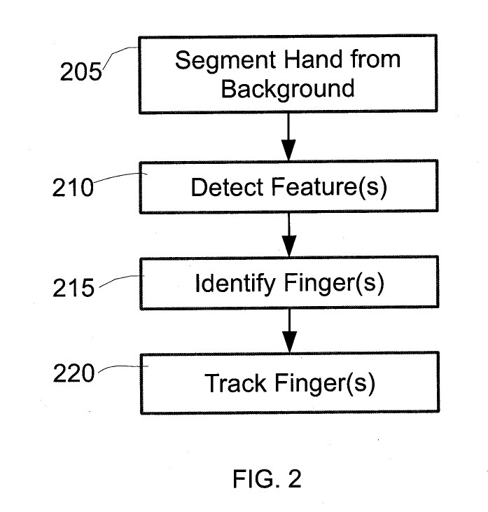

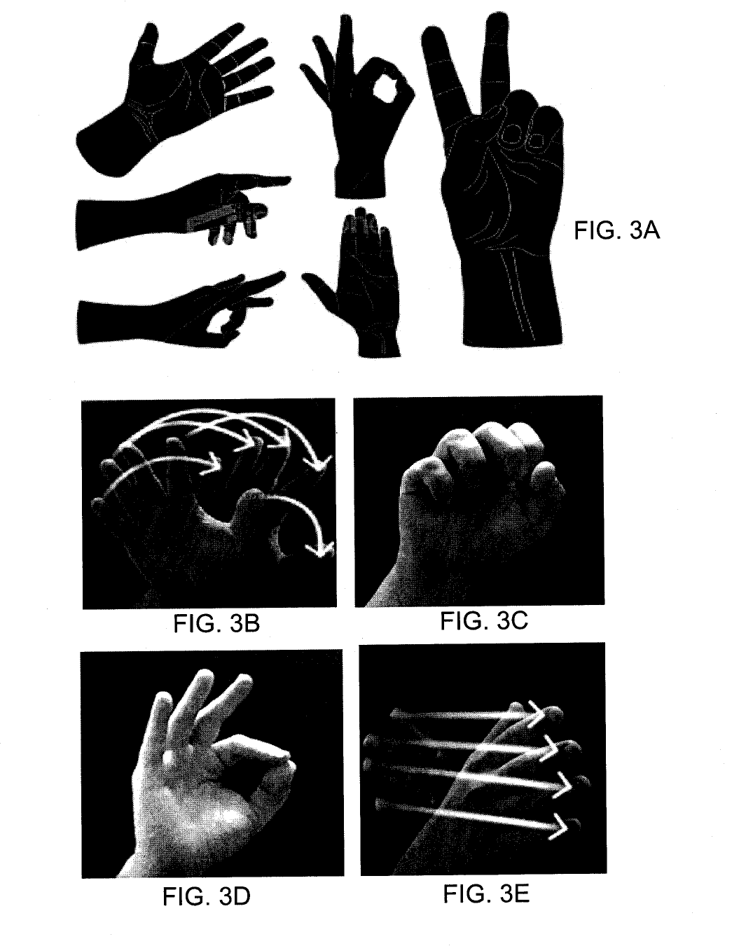

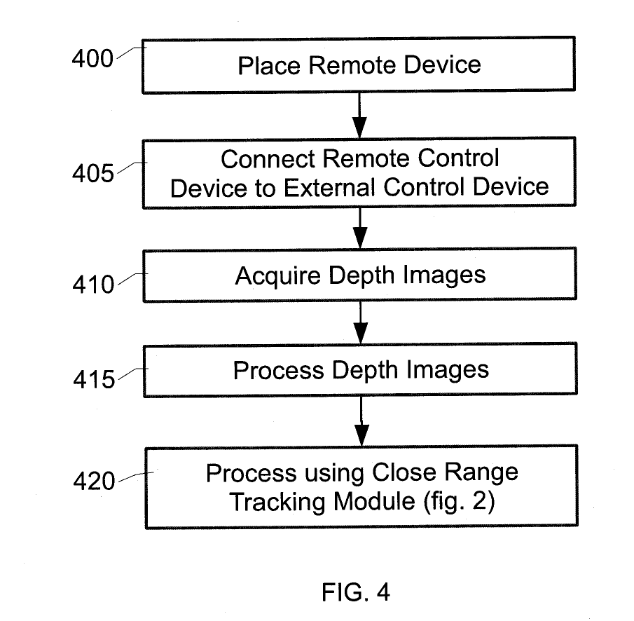

Reference is now made to FIG. 2, which describes an example of how the tracking module 120 processes data generated by a depth sensor to track a user's hand(s) and finger(s), according to some embodiments. As can be seen in FIG. 2, at step 205, the hand is identified from the depth image obtained from the depth sensor, and it is segmented from the background, by removing noise and unwanted background data, using segmentation and/or classification algorithms.

At step 210, features are detected in the depth image and/or associated amplitude and/or associated RGB images. These features may be, for example, the tips of the fingers, the points where the bases of the fingers meet the palm, and any other image data that is possible to detect. The features detected in this feature detection stage are then passed to the finger identification stage, at step 215, where the individual fingers may be identified from these features. At step 220, the fingers are tracked based on their positions in previous frames, in order to filter out possible false-positive features that were detected, and fill in data that may be missing from the depth image data, such as occluded points, or points outside the field-of-view of the depth sensor 110. Optionally, where gesture recognition may be required, the three dimensional positions of the fingers may be obtained from the depth images, and used to construct a skeleton model of the user's hand and fingers. In some embodiments, a kinematics model can be used at this stage, in order to constrain the relative locations of the subject's joints, as well as to compute the positions of joints that are not visible to the camera, either because the joints are occluded, or because the joints are outside the field-of-view of the camera. Of course, tracking may be executed for other parts of the body, or for other objects, besides the hands and fingers.

Reference is now made to FIGS. 3A-3E, which show a series of hand gestures, as examples of fine motor movements that may be detected, tracked, recognized and executed. FIGS. 3A, 3C, and 3D show static hand signal gestures that do not have a movement component, while FIGS. 3B and 3E show dynamic hand gestures. FIGS. 3B and 3E include superimposed arrows showing the movements of the fingers, so as to make a meaningful and recognizable signal or gesture. Of course, other gestures or signals may be detected and tracked, from other parts of a user's body or from other objects. In further examples, gestures or signals from multiple objects or user movements, for example, a movement of two or more fingers simultaneously, may be detected, tracked, recognized and executed. Of course, tracking may be executed for other parts of the body, or for other objects, besides the hands and fingers.

In one example, each of the user's fingers can be mapped to a separate cursor on the display screen. In this way, the user can interact with multiple icons simultaneously. The term “cursor” as used herein may refer to other signals, symbols, indicators etc., such as a movable, sometimes blinking, symbol that indicates the position on a cathode ray tube (CRT) or other type of display where the next character entered from the keyboard will appear, or where user action is needed.

Reference is now made to FIG. 4, which describes an example work-flow for remote control device management in accordance with some embodiments. At step 400, the remote control device, or the device that the depth sensor is embedded on or is coupled to, is placed on a surface. Alternatively, the device can be held by the user, for example, in the user's hand.

At step 405 a communications link is established between the remote control device and the external controlled device. The communications link may utilize a physical or wired based connection, such as an HDMI (high-definition multimedia interface) cable to a television, a USB (universal serial bus) cable to a computer etc., or may be any form of wireless communication, such as infrared, Bluetooth, Wi-Fi, etc. At step 410 the depth sensor 110 may acquire depth images, for example, of the user's hands and fingers. This can be done, for example, by a continuous tracking of the palms and fingers as long as they are inside the field of view of the sensor. At step 415 initial depth data processing may be executed by the depth processor 115. In some examples, initial data processing may generate a depth map to be used by the tracking module 120 for further processing. At step 420 depth image data is processed using a close range tracking module 120, details of which are described above with reference to FIG. 2.

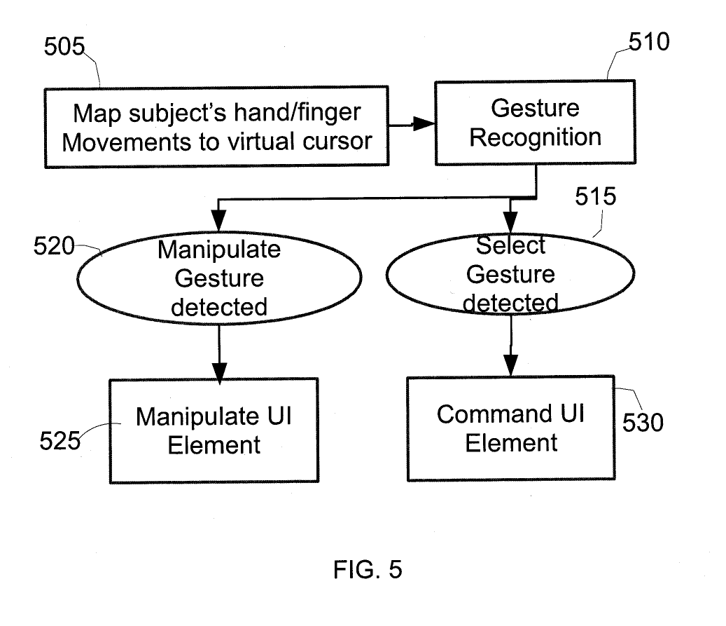

The tracking data generated by the tracking module 120, such as, for example, the position data for the joints, may be passed to one or more modules, optionally in parallel. Reference is now made to FIG. 5, which describes an example of a work-flow related to UI operation, in accordance with some embodiments.

At step 505, in some embodiments, the tracking data derived above may be used to map or project the subject's hand/finger movements to a virtual cursor or other control mechanism or command tool. Optionally, a cursor or command tool may be controlled by one or more fingers. Information can be provided to the subject, for example, on a display screen. The virtual cursor can be a simple graphical element, such as an arrow, or a representation of a hand, or any another element. It may also simply highlight a UI element (without the explicit graphical representation of the cursor on the screen), such as by changing the color of the UI element, or projecting a glow behind it. Different parts of the subject's hand(s) can be used to move the virtual cursor.

In some embodiments, the virtual cursor may be mapped to the subject's hand(s) or one or more finger(s). For example, movements of the index (pointer) finger may map or project directly onto movements of the virtual cursor. The virtual cursor may be allowed to move in three dimensions, so that the virtual cursor can move among UI elements at different levels of depth. In another embodiment, there are multiple virtual cursors, each corresponding to a different one of the subject's fingertips. In another embodiment, movements of the hand(s) away from the screen can impose a zoom effect. Alternatively, the distance between the tips of two fingers, say the index finger and the thumb, can also be used to indicate the level of zoom in the display.

At stage 510, in some embodiments, the tracking data, such as the joints data, may be used to detect gestures that may be performed by the subject. There are two categories of gestures that can be detected that trigger events: select gestures, detected at block 515, and manipulate gestures, detected at block 520. Select gestures may, for example, indicate that a specific UI element should be selected. In some embodiments, a select gesture is a grabbing movement with the hand, where the fingers move towards the center of the palm, as if the subject is picking up the UI element. In another embodiment, a select gesture is done by moving a finger or a hand in a circle, so that the virtual cursor encircles the UI element that the subject wants to select. Of course, other gestures may be used. At stage 530 the system may select and optionally command the UI element(s), in accordance with the user's tracked movements for the identified select gesture.

Manipulate gestures may be used to manipulate a UI element(s) in some way. In some embodiments, a manipulate gesture is performed by the subject rotating his/her own hand, which in turn, rotates the UI element that has been selected, so as to display additional information on the screen. For example, if the UI element is a directory of files, rotating the directory enables the subject to see all of the files contained in the directory. Additional examples of manipulate gestures can include spilling the UI element to (for example) empty its contents onto a virtual desktop, shaking the UI element, which may reorder its contents, or have some other effect, tipping the UI element so the subject can “look inside”, or squeezing the UI element, which may have the effect, for example, of minimizing the UI element. In another embodiment, a swipe gesture can move the selected UI element to the recycle bin.

At step 525 the system may execute the manipulation command on the UI element, according to the particular defined behavior of the gesture or movement performed, and the context of the system. In some embodiments, one or more respective cursors or command mechanisms may be identified with the respective fingertips, to enable navigation, command entry or other manipulation of screen icons, objects or data, by one or more fingers.

In other embodiments, the distance from the screen can be used as a scaling factor. For example, the size of a given object is defined by the distance between the user's thumb and forefinger. However, the distance from the screen can additionally be used as a scaling factor that multiplies this distance between the thumb and forefinger.

In some embodiments, multiple objects on the screen may be selected by the respective fingertips, and may be manipulated in accordance with the fingers' movements. In further embodiments, the distance of the hand or fingers from the screen may affect the size of the screen image. For example, by moving the tracked hand backwards, the screen may zoom out to enable a larger view of the objects being managed. In still further embodiments, screen objects may be overlaid, representing multiple levels of objects to be manipulated. In such cases, depth images of the hand and/or fingers or other objects may be used to manipulate objects at different depths, in accordance with the distance of the hand(s) or finger(s) from the screen.

In still further embodiments, the controlling device may be placed on a surface with the sensor pointed upwards, or in any suitable direction, to enable capture of a depth field proximal to the sensor of the controlling device. In some embodiments, the user may control an external system, platform or device by waving his hands or making predefined gestures near the control device. This embodiment is suitable for tightly confined locations where the user does not have sufficient space to use a laptop or a peripheral camera, or if a very small controlling device is being used, such as a smart-phone.

In some embodiments, the user can hold the controlling device with the sensor in one hand and use the other hand for making movements to be tracked. In some cases, the movements of the controlling device can be compensated for through the use of data obtained from gyroscopes and/or accelerometers coupled to the controlling device.

In some further embodiments, because of the very small field of view and range of the camera, more than one camera can be used, to provide a larger control area.

In accordance with some embodiments, multi-player or multi-user execution of applications, games etc. may be facilitated, by multiple users using remote control devices to control a single external controlled device(s).

Unless the context clearly requires otherwise, throughout the description and the claims, the words “comprise”, “comprising”, and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, 116 will begin with the words “means for.”) Accordingly, the applicant reserves the right to add additional claims after filing the application to pursue such additional claim forms for other aspects of the invention.

We claim:

1. A method for controlling a user interface, the method comprising:
acquiring a first set of close range depth images of a part of a first user's body with a first depth sensor, wherein the first depth sensor is coupled to a first remote control device;
identifying from the first set of depth images movement of the part of the first user's body;
tracking the movement of the part of the first user's body;
providing feedback on the tracked movement of the part of the first user's body;
transmitting a first set of tracking data associated with the tracked movement of the part of the first user's body to a controlled device, wherein the first set of tracking data is used to control the user interface for the controlled device.

2. The method of claim 1, wherein the feedback is provided from the first remote control device.

3. The method of claim 1, wherein the feedback is provided from the controlled device.

4. The method of claim 1, wherein providing feedback on the tracked movement comprises representing the tracked part of the first user's body by a first object on a screen of the controlled device or the first remote control device.

5. The method of claim 4, wherein the identified movement of the part of the first user's body corresponds to a select gesture, wherein the first object is used to select a second object on the screen of the controlled device or the first remote control device.

6. The method of claim 4, wherein the identified movement of the part of the first user's body corresponds to a manipulate gesture, wherein the first object manipulates a second object on the screen of the controlled device or the first remote control device according to a predefined action associated with the manipulate gesture.

7. The method of claim 1, wherein the movement generates a force that interacts with objects on a screen of the controlled device or the first remote control device.

8. The method of claim 1, wherein the part of the first user's body includes one or more fingers and each of the one or more fingers are represented as one or more separate first objects on a screen of the controlled device or the first remote control device, and each of the separate first objects interact with other objects on the screen.

9. The method of claim 1, further comprising:
acquiring a second set of close range depth images of a part of a second user's body with a second depth sensor, wherein the second depth sensor is coupled to a second remote control device;
identifying from the second set of depth images movement of the part of the second user's body;
tracking the movement of the part of the second user's body;
providing feedback on the tracked movement of the part of the second user's body;
transmitting a second set of tracking data associated with the tracked movement of the part of the second user's body to the controlled device, wherein the second set of tracking data is further used to control the user interface for the controlled device.

10. The method of claim 9, wherein the feedback on the tracked movement of the part of the first user's body and the feedback on the tracked movement of the part of the second user's body are provided from the controlled device.

11. The method of claim 9, wherein the feedback on the tracked movement of the part of the first user's body is provided from the first remote control device, and the feedback on the tracked movement of the part of the second user's body is provided from the second remote control device.

12. A system for controlling a user interface, the system comprising:
a remote control device communicatively coupled to a controlled device, wherein the remote control device comprises:
a depth sensor configured to acquire depth images of a user's movements;
an output module configured to transmit information to the controlled device, wherein the information includes data generated by the depth sensor;
the controlled device, wherein the controlled device comprises:
an input module configured to receive the information from the remote control device and convert the information into signals;
a device software module configured to receive the signals from the input module to control the user interface for the controlled device.

13. The system of claim 12, wherein the user's movements are performed by a part of the user's body.

14. The system of claim 12, wherein the remote control device further comprises:
a tracking module configured to track the user's movements, wherein the information transmitted by the output module further includes the tracked user's movements;
a feedback module configured to provide feedback to the user pertaining to the user's tracked movements.

15. The system of claim 14, wherein the remote control device further comprises:
a gesture recognition module configured to identify the tracked user's movements as one or more gestures,
wherein the information transmitted by the output module further includes the identified one or more gestures.

16. The system of claim 12,
wherein the remote control device further comprises:
a tracking module configured to track the user's movements, wherein the information transmitted by the output module further includes the tracked user's movements; and
further wherein the controlled device further comprises:
a feedback module configured to provide feedback to the user pertaining to the user's tracked movements.

17. The system of claim 16, wherein the remote control device further comprises:
a gesture recognition module configured to identify the tracked user's movements as one or more gestures,
wherein the information transmitted by the output module further includes the identified one or more gestures.

18. The system of claim 12, wherein the controlled device further comprises:
a tracking module configured to track the user's movements, wherein the device software module further uses the tracked user's movements to control the user interface for the controlled device;
a feedback module configured to provide feedback to the user pertaining to the user's tracked movements.

19. The system of claim 18, wherein the controlled device further comprises:
a gesture recognition module configured to identify the user's movements as one or more gestures, wherein the device software module further uses the identified one or more gestures to control the user interface for the controlled device.

20. A system for controlling a user interface, the system comprising:
means for acquiring close range depth images of a part of a user's body with a depth sensor, wherein the depth sensor is coupled to a remote control device;
means for identifying from the depth images movement of the part of the user's body;
means for tracking the movement of the part of the user's body;
means for providing feedback on the tracked movement to the user;
means for transmitting tracking data to a controlled device, wherein the tracking data are used to control the user interface for the controlled device.
